(19) United States
(12) Patent Application Publication
(10) Pub. No.: US 2015/0101538 A1
(43) Pub. Date: Apr. 16, 2015

(54) Modular Rigid Small Animal Cage Liner

(71) Applicant: Teresa Murphy, San Mateo, CA (US)

(72) Inventor: Teresa Murphy, San Mateo, CA (US)

(21) Appl. No.: 14/052,678

(22) Filed: Oct. 11, 2013

(51) Int. Cl. A01K 1/015; A01K 1/01

(52) U.S. Cl. CPC A01K 1/0157; A01K 1/0107
USPC 119/169

(57) ABSTRACT

A modular bedding system for small animal cages, comprising a plurality of typically washable, absorbent, rigid panels that are safe and appealing to the animal while insulating it from absorbed liquids. Each panel comprises a washable and soft outer layer, an absorbent inner layer, and a rigid central insert. In the preferred embodiment, the panel is symmetrical in that the absorbent inner layer is present on both sides of the rigid insert. The outer layer and the inner absorbent layer(s) can be taken apart and washed separately. The panels may be moved around or flipped, depending on the animal's toilet habits and/or the owner's decor and cage maintenance preferences. The panels may also comprise other features that may be pleasant to an animal, such as extra bedding, a hill, a pocket for burrowing, or other features.

### CROSS-REFERENCE TO RELATED APPLICATIONS

The present application takes priority from Provisional App. No. 61/712,736, filed Oct. 11, 2012, which is incorporated herein by reference.

### BACKGROUND

1. Field of the Invention

The present invention pertains to small animal care, more specifically to washable, modular cage liners for small animal cages.

2. Background

Small animals such as guinea pigs are extremely popular in the US. Since such animals typically cannot be toilet-trained, their cages are usually lined with wood shavings or other disposable, absorbent material. The absorbent materials must then be disposed and replaced by the pet owner on a regular basis.

However, such disposable products have many drawbacks. They generate dust, which is messy and can aggravate allergies; also, the bedding itself may be kicked out of the cage by the animal, leading to a mess on the floor. They are expensive; the disposable bedding product must be replaced weekly, and can cost up to $20 a bag. Larger cages require even more bedding. Furthermore, these products are environmentally objectionable and lead to large quantities of garbage.

Due to these many problems, reusable cloth cage liners have been proposed. Typically, the prior art cloth cage liner is one large piece of soft material such as fleece, sewn together with a waterproof liner underneath or in the middle between outer material layers. These cloth cage liners absorb the animal's urine, wicking it away from the surface, and may be washed when needed.

One problem associated with reusable cloth cage liners is that while they absorb the animal's urine, they do not absorb the feces, which is typically in hard pellet form. Thus, the pet owner has to sweep up the animal's feces from the surface of the cage liner on a regular basis. Some pet owners use a brush or whisk broom for that purpose; some use a mini-vacuum. However, because the cage liner is a flexible cloth, sweeping or vacuuming it can be awkward and difficult.

Another problem associated with reusable cloth cage liners is that some small animals such as guinea pigs like to paw up the corners and edges of the cage liner to get underneath it. If a cloth cage liner is not secured at the corners and edges, the animal will be able to burrow under it.

One further problem associated with prior art reusable cloth cage liners is that since they typically cover the entire floor of the cage; thus, when a liner needs to be washed, the entire contents of the cage must be removed, and a cumbersomely large liner must be handled and transported. Since reusable cloth cage liners need to be washed relatively frequently, this is inconvenient for the user.

A need therefore exists for a reusable cage liner that is easy to brush or vacuum, that does not permit an animal to burrow underneath it, and that is easy to remove from the cage when it needs to be washed, and which does not involve the handling of large pieces of material.

### SUMMARY OF THE PRESENT INVENTION

An object of the present invention is to provide a reusable cage liner that is modular, rigid, absorbent, and easy to replace.

The preferred embodiment of the present invention comprises a plurality of rectangular panels, each panel comprising an outer layer, an inner absorbent pad, and a rigid insert. The outer layer is preferably made of fleece or a similar material that separates them from urine absorbed below, is appealing and safe for an animal to stand or lie on, and is configured like an envelope or pillow case. The inner absorbent pad is preferably made of a material that is washable and highly absorbent, and is approximately twice the size of the outer layer. Alternatively, the absorbent pads may be of a disposable material, including possible relatively rigid configurations either folded over the center layer or in separate above and below the center panel layers. In the preferred embodiment, the inner absorbent pad is made of a U-Haul pad. Finally, the rigid insert is a rigid or semi-rigid sheet of plastic or other waterproof material that is close in size to the outer layer. To assemble one panel, the user would typically fold the inner absorbent pad(s) in half, insert the rigid insert in the middle, and insert both of them into the outer pillowcase-configured layer.

While in the preferred embodiment, the panels are symmetrical, this is not required for the invention. Another embodiment of the invention comprises an absorbent pad that is the same size as the rigid insert, with both of them inserted into the outer layer. This embodiment of the invention may not be flipped over to get more use out of the panel before it needs to be washed, however. Or such absorbent pads can be provided on both sides of the center panel, in order to provide for the flip-over functionality.

Since the panels are relatively rigid, the animal will not be able to burrow underneath them; this leads to a cleaner cage. Also, their rigidity makes them easy to vacuum or brush to remove the animal's feces, or other debris such as spilled food. The user may even tilt a panel to make it easier to brush the feces into a dustpan or similar device.

Since several panels are used, the user may remove only a few of them at a time for cleaning. The user can also move the panels around within the cage, to move a less-used panel to a more heavily used area, or flip a panel over to expose an unused surface.

Because the preferred embodiment of the invention is modular, different components can be changed depending on the animal's needs. For example, since many small animals have a particular corner of their cage they like to use for urination, the panel used in that corner could have a special high-absorbency absorbent pad, or an extra absorbent pad inserted.

Another embodiment of the present invention comprises pockets or other features in the outer layer, to give the animal a space to hide, a tunnel to climb through, a hill to climb, or a softer spot to sleep. Since the panels are modular, the user can configure the animal's cage in a way that provides the animal with the maximum comfort and interesting features.

The outer layer may be available in several different colors or patterns to enable the user to change the look of the cage by rearranging the panels. The outer layer may also be one color/pattern on one side and another color/pattern on the other.

The present invention was conceived for small caged pets such as guinea pigs or hedgehogs, but is expected to find successful application with many other animals.

### LIST OF FIGURES

FIG. 1 shows an assembled view of one panel of the preferred embodiment of the present invention.

FIG. 2 shows an exploded view of one panel of the preferred embodiment of the present invention.

FIG. 3 is a photograph of the preferred embodiment of the present invention in use.

### DETAILED DESCRIPTION OF THE PREFERRED EMBODIMENT

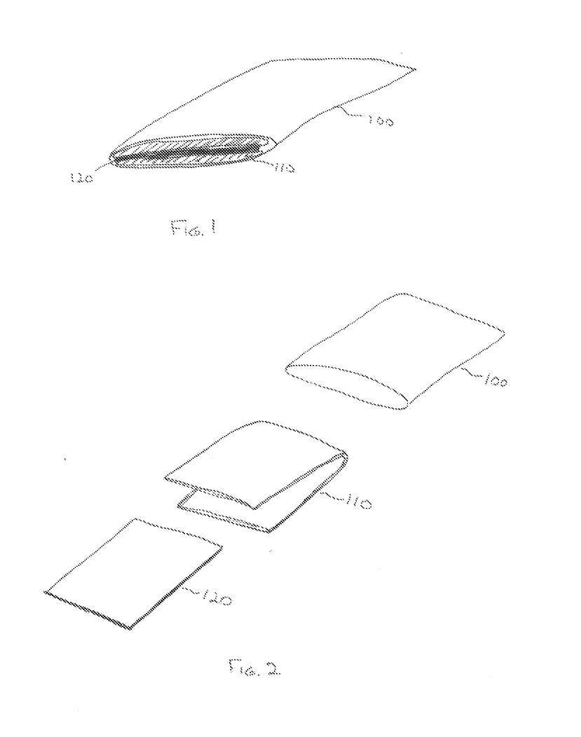

As shown in FIGS. 1 and 2, in the preferred embodiment, one panel comprises an outer pillowcase-like layer 100, one or more absorbent pads 110, and a rigid central insert 120. The absorbent pad(s) 110 is folded over the rigid insert 120, and then both the rigid insert 120 and the absorbent pad(s) 110 are inserted into the outer layer 100. FIG. 2 shows an exploded view of the panel of the preferred embodiment.

The rigid insert 120 can be made of any material that is rigid, chemically stable when exposed to urine or feces, and impermeable to water. The preferred material is 4 mm Coroplast. The corners of the rigid insert may also be rounded for safety and ease of use.

The absorbent pad 110 can be made of any material that can absorb fluids and is washable. In the preferred embodiment, the absorbent pad is a U-Haul pad cut to the desired dimensions. The absorbent pad can also comprise scented or odor-absorbing materials to reduce unpleasant odors.

The outer layer 100 can be made of any material that is soft and appealing to the animal, washable, allows fluids to pass through, and helps to keep the animal separated from the fluids passed through to the internal layers. In the preferred embodiment, the outer layer is made of fleece.

The pads can be any size, though preferably several pads should be used per cage to get the benefit of the modularity of the invention.

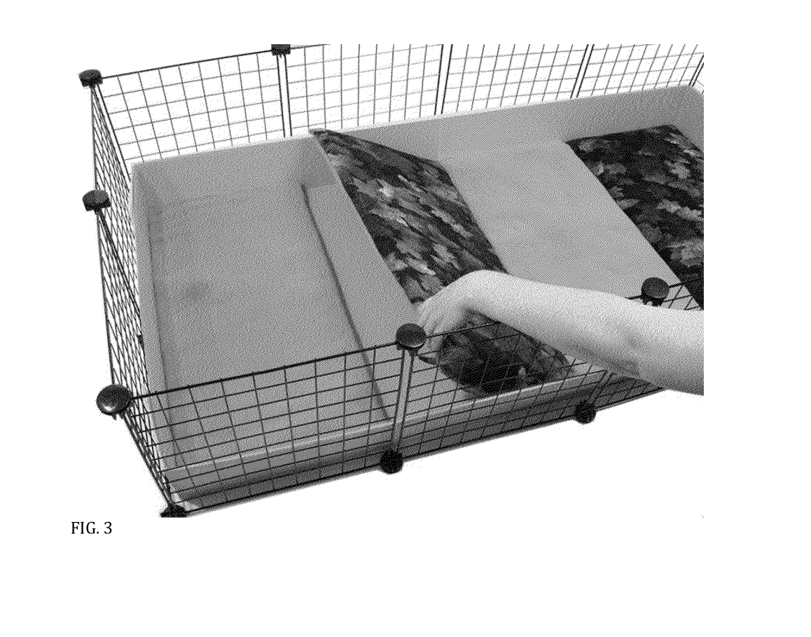

FIG. 3 is a photograph showing the invention in use in a guinea pig enclosure. Four panels are visible at the bottom of the enclosure. The panels span the entire width of the enclosure, to ensure secure placement.

In an alternate embodiment of the invention (not shown), at least some of the panels comprise additional features that can provide the animal with an enriched environment. For example, one of the panels can also comprise a pocket attached to the outer layer, appropriately sized for a small animal, so that the animal has a place to hide. Other panels can comprise a tunnel for the animal to climb through, or a hill for the animal to climb, or an extra soft pillow for the animal to sleep on. Any given panel may have multiple additional features on either or both sides of the panel.

In an alternate embodiment of the invention (not shown), the absorbent pads come in different absorbencies. The user may select a higher-absorbency pad for the corner of the cage that the animal uses as its toilet, and lower-absorbency pads for the rest of the cage.

In another embodiment (not shown), at least one panel comprises multiple absorbent pads. This provides a greater absorbency without requiring multiple types of absorbent pads.

1. A cage liner for a small animal cage, comprising:
a plurality of panels, each panel comprising:
a rigid insert;
an inner absorbent pad on at least one side of the rigid insert, said inner absorbent pad being of a size that approximately covers the entirety of the rigid insert;
an outer cover that encloses both the rigid insert and the inner absorbent pad, said outer cover being almost exactly the same size as the rigid insert.

2. The cage liner of claim 1, where the plurality of panels cover the entire bottom of the cage.

3. The cage liner of claim 1, where each outer cover is washable.

4. The cage liner of claim 1, where each inner absorbent pad is washable.

5. The cage liner of claim 1, where at least one inner absorbent pad comprises odor-absorbing chemicals.

6. The cage liner of claim 1, where at least one inner absorbent pad is scented.

7. The cage liner of claim 1, where the inner absorbent pad is twice the size of the rigid insert and folded in half with the rigid central insert in the middle.

8. The cage liner of claim 1, where the inner absorbent pad is in a pillowcase configuration around the central insert in the middle.

9. The cage liner of claim 1, where the rigid central insert is impervious to liquid.

10. The cage liner of claim 1, where the outer cover comprises a wicking material.

11. The cage liner of claim 1, where at least one panel's outer cover comprises a pocket, said pocket being large enough to at least partially contain a small animal.

12. The cage liner of claim 1, where at least one panel's outer cover comprises an attachment in the shape of a tunnel, said tunnel being large enough for a small animal to fit through.

13. The cage liner of claim 1, where at least one panel further comprises a pillow, said pillow being appropriately sized for a small animal to sleep on.

14. The cage liner of claim 1, where at least one panel further comprises a sloped insert, said sloped insert intended to provide a small animal with a sloped surface to climb.

15. The cage liner of claim 1, where at least one panel's inner absorbent pad is of a higher absorbency than the inner absorbent pads of the other panels.

16. The cage liner of claim 1, where at least one panel's outer cover comprises a first color or pattern on one side, and a second color or pattern distinct from the first color or pattern on the other side.

17. A cage liner for a small animal cage, comprising:
a plurality of panels, each panel comprising:
a rigid insert;
an inner absorbent pad on at least one side of the rigid insert, said inner absorbent pad being of a size that approximately covers the entirety of the rigid insert;
an outer cover that encloses both the rigid insert and the inner absorbent pad, said outer cover being almost exactly the same size as the rigid insert.

18. The cage liner of claim 1, where the plurality of panels cover the entire bottom of the cage.

19. The cage liner of claim 1, where each outer cover is washable.

20. The cage liner of claim 1, where each inner absorbent pad is washable.

21. The cage liner of claim 1, where at least one inner absorbent pad comprises odor-absorbing chemicals.

22. The cage liner of claim 1, where at least one inner absorbent pad is scented.

23. The cage liner of claim 1, where the inner absorbent pad is twice the size of the rigid insert and folded in half with the rigid central insert in the middle.

24. The cage liner of claim 1, where the inner absorbent pad is in a pillowcase configuration around the central insert in the middle.

25. The cage liner of claim 1, where the rigid central insert is impervious to liquid.

26. The cage liner of claim 1, where the outer cover comprises a wicking material.

27. The cage liner of claim 1, where at least one panel's outer cover comprises a pocket, said pocket being large enough to at least partially contain a small animal.

28. The cage liner of claim 1, where at least one panel's outer cover comprises an attachment in the shape of a tunnel, said tunnel being large enough for a small animal to fit through.

29. The cage liner of claim 1, where at least one panel further comprises a pillow, said pillow being appropriately sized for a small animal to sleep on.

30. The cage liner of claim 1, where at least one panel further comprises a sloped insert, said sloped insert intended to provide a small animal with a sloped surface to climb.

31. The cage liner of claim 1, where at least one panel's inner absorbent pad is of a higher absorbency than the inner absorbent pads of the other panels.

32. The cage liner of claim 1, where at least one panel's outer cover comprises a first color or pattern on one side, and a second color or pattern distinct from the first color or pattern on the other side.
